(19) United States
(12) Patent Application Publication
(10) Pub. No.: US 2006/0167823 A1
(43) Pub. Date: Jul. 27, 2006

(54) Secure wireless commerce

(76) Inventors: William York, Folsom, CA (US); Michael Nowakowski, Folsom, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/026,124

(22) Filed: Dec. 31, 2004

(51) Int. Cl. G06Q 99/00; H04L 9/00; H04K 1/00

(52) U.S. Cl. 705/76

(57) ABSTRACT

Method and apparatus for secure wireless commerce are described.

### BACKGROUND

Electronic commerce may be defined as the buying and selling of goods and services, and the transfer of funds, through digital communications. The processing of such economic transactions of buying and selling through electronic communication from retailers, wholesalers, mail order companies, and the like, is becoming more prevalent. Thus, methods and systems to provide electronic monetary transactions in such an electronic environment where business is established electronically over the Internet and business communication and transactions is conducted over networks and through computers are becoming commonplace. This includes both electronic sales (internet shops) and business-to-business (B2B) transactions, i.e., business transactions between two companies, and buying and selling products with digital cash and via Electronic Data Interchange (EDI). Electronic commerce also includes buying and selling over the World-Wide Web and the Internet, electronic funds transfer, smart cards, digital cash (e.g., Mondex), and all other ways of doing business over digital networks. There is, however, no single point or secure method of payment where a buyer may select a payment account to fund a particular transaction over a wireless device, such as, for example, a cellular device, for example Conventional electronic commerce systems and methods provide limited security with credit cards being one of the more prevalent money generators or monetary transaction devices. These become inconvenient to use, especially when a user has multiple credit cards at his or her disposal. Furthermore, conventional monetary transaction devices do not provide real-time access to balances of multiple accounts.

### BRIEF DESCRIPTION OF THE DRAWINGS

FIG. 1 illustrates a block diagram of a system 100.

FIG. 2 illustrates a block diagram of node 102.

FIG. 3 illustrates a block diagram of node 104.

FIG. 4 illustrates a block diagram of node 106.

FIG. 5 illustrates a block diagram of node 108.

FIG. 6 illustrates a block diagram of a system 600.

FIG. 7 illustrates a block diagram of a programming logic 700.

FIG. 8 illustrates a block diagram of a programming logic 800.

### DETAILED DESCRIPTION

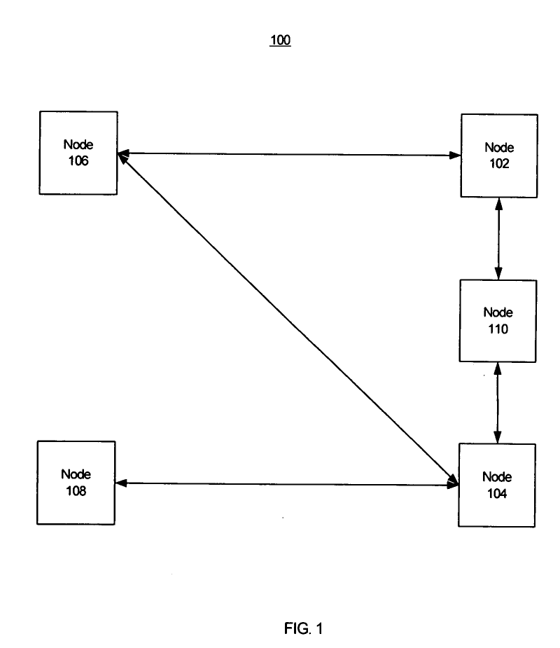

FIG. 1 illustrates a block diagram of a system 100. In one embodiment, system 100 may comprise, for example, a multipurpose secure electronic monetary transaction system. System 100 may comprise, for example, a communication system having multiple nodes. A node may comprise any physical or logical entity having a unique address in system 100. Examples of a node may include, but are not necessarily limited to, a computer, server, workstation, laptop, ultra-laptop, handheld computer, telephone, network device, proprietary network device, portable digital music player, set-top box, cellular telephone, mobile telephone, wireless device, personal digital assistant (PDA), networked PDA, pager, two-way pager, eWallet, router, switch, bridge, hub, gateway, wireless access point (WAP), and so forth. The unique address may comprise, for example, a network address such as an Internet Protocol (IP) address, a device address such as a Media Access Control (MAC) address, and so forth. The embodiments are not limited in this context.

The nodes of system 100 may be arranged to communicate different types of information, such as media information and control information. Media information may refer to any data representing content meant for a user, such as monetary transaction information, credit card account information, financial account information (e.g., banking, investment, brokerage, retirement, checking, savings, debit, stock, bonds, money market, etc.), security information, authentication information, identity management information, security assertion information, and so forth. Such media information may take the form of voice information, video information, audio information, text information, alphanumeric symbols, graphics, images, and so forth. Control information may refer to any data representing commands, instructions or control words meant for an automated system. For example, control information may be used to route media information through a system, or instruct a node to process the media information in a predetermined manner.

The nodes of system 100 may communicate media and control information in accordance with one or more protocols. A protocol may comprise a set of predefined rules or instructions to control how the nodes communicate information between each other. The protocol may be defined by one or more protocol standards as promulgated by a standards organization, such as the Internet Engineering Task Force (IETF), International Telecommunications Union (ITU), the Institute of Electrical and Electronics Engineers (IEEE), and so forth. For example, system 100 may operate in accordance with one or more financial transaction protocols, financial transaction interchange protocols, Simple Object Access Protocol (SOAP), ISO 8583 protocol, Online Certificate Status Checking Protocol (OCSP), NetBill Security and Transaction Protocol, Business Transaction Protocol (BTP), Credit Card/Point-of-Sale (POS) protocol, VISA protocol, Secure Electronic Transaction Protocol (SET), Open Trading Protocol (OTP), XML-based message protocol, among others, for example.

System 100 may be implemented as a wired communication system, a wireless communication system, or a combination of both. Although system 100 may be illustrated using a particular communications media by way of example, it may be appreciated that the principles and techniques discussed herein may be implemented using any type of communication media and accompanying technology. The embodiments are not limited in this context.

When implemented as a wired system, system 100 may include one or more nodes arranged to communicate information over one or more wired communications media. Examples of wired communications media may include a wire, cable, printed circuit board (PCB), backplane, switch fabric, semiconductor material, twisted-pair wire, co-axial cable, fiber optics, and so forth. The communications media may be connected to a node using an input/output (I/O) adapter. The I/O adapter may be arranged to operate with any suitable technique for controlling information signals between nodes using a desired set of communications protocols, services or operating procedures. The I/O adapter may also include the appropriate physical connectors to connect the I/O adapter with a corresponding communications medium. Examples of an I/O adapter may include a network interface, a network interface card (NIC), disc controller, video controller, audio controller, and so forth. The embodiments are not limited in this context.

When implemented as a wireless system, system 100 may include one or more wireless nodes arranged to communicate information over one or more types of wireless communication media. An example of a wireless communication media may include portions of a wireless spectrum, such as the radio-frequency (RF) spectrum. The wireless nodes may include components and interfaces suitable for communicating information signals over the designated wireless spectrum, such as one or more antennas, wireless transmitters/receivers (“transceivers”), wireless repeaters, Wireless Access Points (WAP), amplifiers, filters, control logic, and so forth. Examples for the antenna may include an internal antenna, an omni-directional antenna, a monopole antenna, a dipole antenna, an end fed antenna, a circularly polarized antenna, a micro-strip antenna, a diversity antenna, a dual antenna, an antenna array, and so forth. The embodiments are not limited in this context.

Referring again to FIG. 1, system 100 may comprise nodes 102, 104, 106, 108, and 110, for example. Although FIG. 1 is shown with a limited number of nodes in a certain topology, it may be appreciated that system 100 may include more or less nodes in any type of topology as desired for a given implementation. The embodiments are not limited in this context.

In one embodiment, system 100 may comprise transaction device node 102. Transaction device node 102 may represent a user electronic financial transaction device (hereinafter “transaction device”). The user may use transaction device node 102 to view and pay a bill associated with a transaction with a provider. The term “provider” used throughout this description refers at least to any provider of goods, merchandise, and/or services such as, for example, a merchandiser, retailer, merchant, wholesaler, personal, restaurant, vendor, and so forth, for example. Transaction device node 102 may be used to exchange information between users and providers and central infrastructure node 104. Transaction device node 102 may be used to initiate and conduct electronic and secure wireless transactions directly from credit card and/or debit card accounts, for example. In one embodiment, transaction device node 102 may be used in secured cellular e'commerce transactions and may provide a multi-factor authentication for payment authorization. In one embodiment, a provider's bill may be displayed on transaction device node 102 and gives the user the ability to pay directly from credit or debit card via transaction device node 102. The embodiments are not limited in this context.

In one embodiment, system 100 may comprise a central infrastructure node 104. Central infrastructure node 104 may comprise, for example, a central infrastructure to process financial transactions between a user and a provider. Central infrastructure node 104 may validate a user and provide a user with a detailed bill from a provider and also allows the user to select payment from a predetermined financial account such as, for example, debit card, credit card, and so forth. In one embodiment, central infrastructure node 104 provides data storage for all individual financial accounts associated with a user and may authenticate, access, and authorize a particular financial transaction via transaction device node 102. Central infrastructure node 104 also may provide any necessary data format conversions to properly interface with servers associated wit a provider. A user may access central infrastructure node 104 through a web based connection via a web portal, for example, using a computer with internet access. In one embodiment, the user may access central infrastructure node 104 via communication infrastructure node 110, which may represent a wired or wireless (or combinations thereof) communication infrastructure. Central infrastructure node 104 may comprise, for example, one or more networked servers comprising a user database, for example. The embodiments are not limited in this context.

In one embodiment, system 100 may further comprise node provider 106. Provider node 106 may represent a provider, a space occupied by a provider, and/or a machine used in the provision of goods, merchandise, services, and so forth, to a user, for example, a POS system. A user may conduct a transaction with provider node 106 via transaction device node 102 either directly with provider node 106 or through communication infrastructure node 110 and central infrastructure node 104, for example. Provider node 106 may comprise the necessary interface to central infrastructure node 104 and the necessary servers and other computers to process a financial transaction.

In one embodiment, system 100 may further comprise financial institution node 108. Financial institution node 108 may represent servers associated with a financial institution, for example. The servers may include any financial information associated with the user such as, for example, credit card information, credit card authentication information, credit card account information, financial account information (e.g., banking, investment, brokerage, retirement, checking, savings, debit, stock, bonds, money market, etc.), and so forth. The servers associated with financial institution node 108 are in communication with central infrastructure node 104. In one embodiment, central infrastructure node 104 may leverage existing technologies like SAML, ECML, FIM, XML, SOAP, FIM, and so forth, to be compatible across different environments, for example. The embodiments are not limited in this context.

In general operation, system 100 may operate to eliminate physical credit cards and debit cards. All individual user accounts may be stored centrally at central infrastructure node 104. Central infrastructure node 104 allows user authentication, access, and authorization through transaction device node 102. In one embodiment, when a user purchases any one of the transaction devices described herein, a transaction device manufacturer or provider may install a digital certificate in transaction device node 102 such as, for example, a unique non-migratable private key onto a Trusted Platform Module (TPM). In one embodiment, this capability may be included in the silicon/processor engine of the transaction device, for example. In one embodiment, transaction device node 102 may comprise XScale Architecture by Intel, for example.

In one embodiment, additional authentication methods and/or mechanisms like unique passwords and/or biometric information also may be employed to provide additional security at the transaction device level. For example, in one embodiment, a primary authentication mechanism may be located on the transaction device. This authentication may take the form of a private key as well as a unique password selected by a user and/or biometric identification element, for example. Once the primary authentication mechanism is set (e.g., private key, unique password, biometric data), the user may establish an account with central infrastructure node 104 through a web based connection (e.g., home computer with internet access). The embodiments, however, are not limited in this context.

The user then may set up a unique password via a secondary authentication on node 102 that may be used in conjunction with the digital certificate as a mechanism of secondary authentication to central infrastructure node 104, for example. In one embodiment, the secondary authentication mechanism may be located, provided, and/or administered by a network node or website. For example, central infrastructure node 104 may require a user to log into a website to set up an account. Thus, the website may require that a user enter a password or some other type of security mechanism to log into central infrastructure 102 and set-up an original account. Accordingly, the user may access a Web Portal associated with central infrastructure node 104, setup their account(s) and provide any required specific information to their credit\debit sources. The user also may link a transaction device node 102 with this account. After the user account setup is complete, the user may securely authenticate into central infrastructure node 104 to view their account information. Users also may be able to walk into any provider and receive an invoice\bill on a transaction device node 102. At the time of a transaction, the user may give the provider a number associated with transaction device node 102 (e.g., if the transaction device is a cellular phone, the user may give the provider the cellular phone number) to enter into provider's node 106. This event may trigger a response to central infrastructure node 104, for example, via ECML protocol, and in this manner send a request to user's transaction device node 102. For example, if transaction device node 102 is a cellular phone, the request may be sent using XML for communications with central infrastructure node 104. The user then may authenticate this request and select an account, which was established in a previous transaction with central infrastructure node 104, to be deducted for the goods, merchandise, services rendered by the provider. The user also may view any current balances and available credit on each account registered with central infrastructure node 104 to ensure adequate credit limit to pay the bill, for example. Central infrastructure node 104 may then authorize this account and request that a lender or financial institution node 108 to submit the transaction to the provider. Provider node 106 sends a confirmation to transaction device node 102 and the transaction is completed. The embodiments, however, are not limited in this context.

In one embodiment, a tertiary authentication mechanism also may be located, provided, and/or administered by a network node or website. For example, central infrastructure node 104 may require a user to enter another password or some other type of security mechanism to allow a user to modify an existing account, add a new account, delete a current account, and other similar transactions. The embodiments, however, are not limited in this context.

In one embodiment, the transaction device may contain the necessary primary security mechanism such as private key, password protection, and/or biometrics to allow a user to access central infrastructure 104. In one embodiment, although the primary security mechanism may allow a user to access the transaction device, the user may not be able to make transactions with the transaction device unless the secondary and/or tertiary security mechanisms are met. In one embodiment, data stored in the transaction device may be encrypted, for example, to prevent unauthorized use of the transaction device. In one embodiment, data remaining in the transaction's device memory (e.g., cache memory) also may be encrypted to prevent unauthorized use of the transaction device.

In one embodiment, system 100 may provide, for example, an electronic wallet (e'wallet) so there would be no need for a user to physically carry debit or credit cards to engage in transactions with a provider. System 100 also provides an authentication feature to the user's unified credit information located or stored in central infrastructure node 104. Furthermore, because there is no physical debit or credit card to carry, system 100 is more secure from fraud protection against lost or stolen cards. Also, as described above, system 100 provides secondary and/or tertiary authentication to complete an electronic transactions with transaction device node 102. With secondary and/or tertiary authentication, system 100 also provides instant and dynamic access to all financial accounts setup within central infrastructure node 104. Also, the user may retrieve available balance (and total balance) on each account before paying any bill, for example. In addition, if transaction device node 102 is lost or stolen, the user's accounts may be secured with the user's password using the secondary and/or tertiary authentication feature. In addition, a user may freeze all accounts with a single phone call to central infrastructure node 104 to prevent unauthorized transactions. The embodiments are not limited in this context. Further, a user may modify existing accounts, add new accounts, delete current accounts, and conduct other similar transactions, for example. The embodiments, however, are not limited in this context.

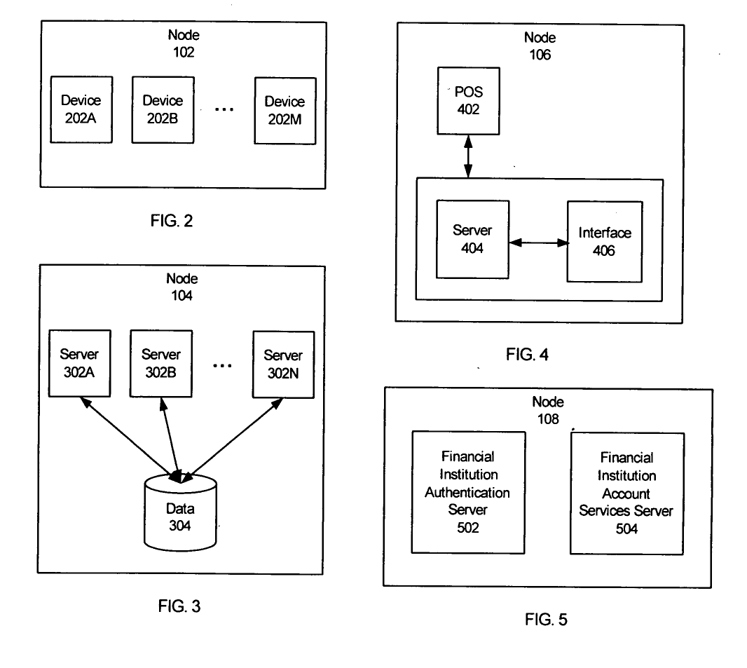

FIG. 2 illustrates a block diagram of transaction device node 102. As shown in FIG. 2, transaction device node 102 may comprise multiple elements such as, for example, one or more transaction devices 202A, 202B, 202M to conduct transactions with providers and central infrastructure node 104. Transaction device node 102 may include, for example, a computer, server, workstation, laptop, ultra-laptop, handheld computer, telephone, network device, proprietary network device, portable digital music player, set-top box, cellular telephone, mobile telephone, wireless device, personal digital assistant (PDA), networked PDA, pager, two-way pager, e'wallet, and/or a device integrated with a merchant\retailer POS (Point of Sale) system. In one embodiment, the transaction device may be integrated with Single Sign On (SSO) technology. The embodiments are not limited in this context.

FIG. 3 illustrates a block diagram of central infrastructure node 104 comprising the central infrastructure, for example, to process financial transactions between a user and a provider. As shown in FIG. 3, node 104 may comprise multiple elements such as, for example, one or more servers 302A, 302B, 302N. Servers 302A, B, N may be networked. At least one of the servers may be connected to a database 304 that comprises at least a user's individual financial accounts. Servers 302A, B, N provide the necessary functionality to authenticate, access, and authorize a user's financial transaction with a provider via the transaction device. At least one of servers 302A, B, N may provide the necessary functionality to interface with a variety of provider computer systems. The embodiments are not limited in this context.

FIG. 4 illustrates a block diagram of provider node 106. As shown in FIG. 4, provider node 106 may comprise multiple elements, such as, for example a point-of-sale system 402 (POS), for example. Those skilled in the art will appreciate that a POS system 402 may comprise, for example, computer equipment and software specialized for retail point-of-sale, particularly cash drawers, pole displays, receipt printers, bar-code scanners and software that supports them. Further, a POS system 402 also may comprise, for example, a relatively basic terminal with magnetic stripe reader, keyboard, display and autodialer modem, connected to a telephone network and used for on-line credit/debit authorization and/or a more complex terminal including the above features less modem, connected to a host computer, which handles all transaction processing including item price look-up, data collection, and credit/debit authorization, for example. In one embodiment, POS system 402 may be connected to a server 404. In one embodiment, server 404 may be a provider's Micros central server for POS processing, for example. In one embodiment, server 404 may be connected to interface server 406 to interface between the Micros processing server 404 and at least one of central infrastructure servers 302A, B, N. The embodiments are not limited in this context.

FIG. 5 illustrates a block diagram of financial institution node 108. As shown in FIG. 5, financial institution node 108 may comprise multiple elements, such as, for example a financial institution authentication server 502 and a financial institution account services server 504. Authentication server 502 may be used to provide credit card authentication services to central infrastructure node 104. Account services server 504 may be used to provide available balances in a user's accounts to central infrastructure node 104. The embodiments are not limited in this context.

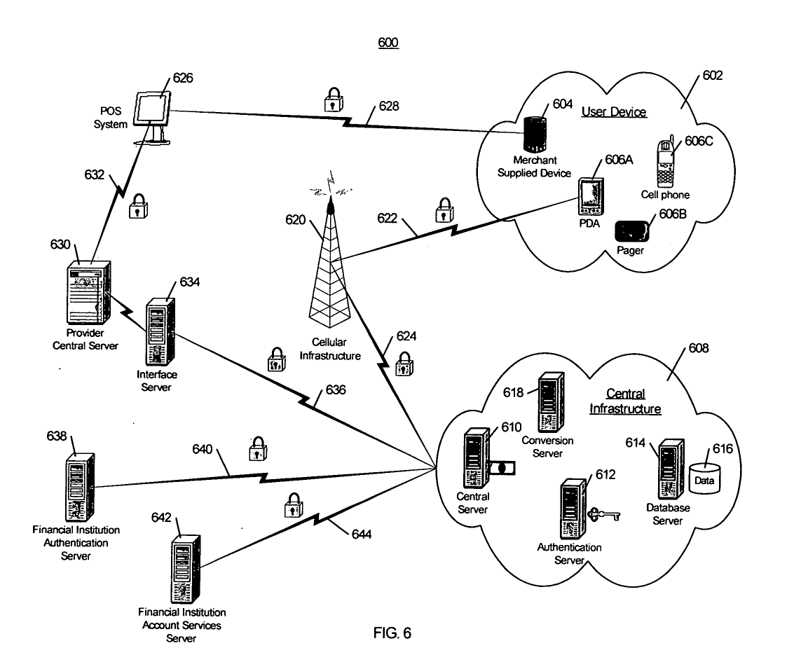

FIG. 6 illustrates a block diagram of system 600. As shown, system 600 comprises multiple elements. As shown, system 600 may comprise one or more transaction devices 602. In one embodiment, a transaction device 602 may comprise a merchant supplied device 604 that interfaces directly with a provider's POS system 626, for example, via communication link 628. As shown, communication link 628 may be a secure link and may be either a wireless or a wired link, for example. In one embodiment, transaction device 602 may be any one of a PDA 606A, a pager 606B, and/or a cell phone 606C, among other devices described herein. Wireless transaction devices 606A, B, C may interface with a wireless communication infrastructure 620, such as a cellular infrastructure, for example. When the user wants to complete a transaction with a provider, the user may use wireless transaction devices 606A, B, C to establish communication with central infrastructure 608 via secure communication links 622, 624, for example. As described above, a primary authentication mechanism may be located directly on wireless transaction device 606A, B, C, for example. Once connected to central infrastructure 608, the user may obtain validation information and a detailed bill from the provider, and also may select the form of payment, such as credit or debit card transaction. In one embodiment, when a user purchases any one of transaction devices 602 described herein, the provider of the transaction device may install a digital certificate in transaction device 602 such as, for example, a unique non-migratable private key onto a TPM. In one embodiment, this capability may be included in the silicon/processor engine of transaction device 602, for example. In one embodiment, transaction device 602 may comprise XScale Architecture by Intel, for example. The embodiments are not limited in this context.

System 600 also may comprise central infrastructure 608. In one embodiment, central infrastructure 608 comprises a central server 610, authentication server 612, database server 614 with user database 616, and conversion server 618, for example. Central server 610 may represent a provider transaction server, for example. Central server 610 interfaces with interface server 634 through secure communication link 636 and is connected with provider central server 630 to communicate with POS system 626 through secure communication link 632 and conduct the transaction. The embodiments are not limited in this context.

Central infrastructure 608 also may comprise authentication server 612 to verify the user's secondary and/or tertiary authentication mechanism as described above. In one embodiment, authentication server 612 may provide user payment authorization, for example. As a mechanism of secondary authentication to central infrastructure 608, the user may set a unique password that may be used in conjunction with any one of the primary authentication mechanisms described above, such as, for example, a digital certificate, password, biometrics data, and the like for example. In one embodiment, a tertiary authentication mechanism may be employed to allow the user to modify, add, and/or delete accounts located in central infrastructure 608, for example. Once the user sets a unique password to access central infrastructure 608 via secondary authentication, the user may setup his account information on central infrastructure 608 through a web based connection (e.g., home computer with internet access). Accordingly, the user may go to a Web Portal associated with the central infrastructure and setup their account(s) and provide any required specific information to their credit\debit sources. The user also may link transaction device 602 along with any primary authentication mechanisms, for example, with this account. After account setup is complete, the user may securely authenticate into central infrastructure 608 to view their account information. Users also may be able to walk into any provider and receive their invoice\bill on their transaction device. Accordingly, central infrastructure 608 allows user authentication, access, and authorization through transaction device 602. Further, as described above, after account setup is complete, a user may modify, add, and/or delete accounts located in central infrastructure 608 using the tertiary authentication mechanisms described above, for example. Authentication server 612 may communicate with financial institution authentication server 638 via secure communication link 640 to authenticate the user's credit card accounts. Database server 614 and user database 616 may contain any data or information associated with a user, such as, for example, user associated with authentication, accounts, preferences, contact information, and so forth. Database server 614 may communicate with one or more financial institution account services server 642 via secure communication 644 to access all of a user's accounts. All individual user accounts may be stored centrally at central infrastructure 608 user database 616, for example. Conversion server 618 may convert central infrastructure 608 data and command format into the Micros POS system format. The embodiments are not limited in this context.

In general operation, system 600 may operate to eliminate physical credit cards and debit cards. At the time of a provider/user transaction (e.g., purchase of goods, merchandise, or services from a provider by a user), the user may give the provider a number associated with transaction device 602 (e.g., if the transaction device is a cellular phone, the user may give the provider the cellular phone number) to enter into POS system 626. This event may trigger a response to central infrastructure 608 through provider central server 630 and interface server 634, for example. This communication may be conducted in accordance with ECML protocol, for example. Central infrastructure 608 responds to the trigger event by sending a request to transaction device 602. For example, if transaction device 602 is cellular phone 606C, the request may be sent using XML for communications with central infrastructure 608. The user may authenticate the request and select an account, which was established in a previous transaction with central infrastructure 608, to be deducted for the goods, merchandise, services rendered by the provider. The user also may view any current balances and available credit on each account registered with central infrastructure 608 to ensure adequate credit limit to pay the bill, for example. Central infrastructure 608 may then authorize this account and request that a lender or financial institution submit the transaction to the provider via servers 638 and/or 642, for example. Provider's POS system 626 then sends confirmation to transaction device 602 and the transaction is completed. The embodiments are not limited in this context.

Operations for the above system and subsystem may be further described with reference to the following figures and accompanying examples. Some of the figures may include programming logic. Although such figures presented herein may include a particular programming logic, it can be appreciated that the programming logic merely provides an example of how the general functionality described herein can be implemented. Further, the given programming logic does not necessarily have to be executed in the order presented unless otherwise indicated. In addition, the given programming logic may be implemented by a hardware element, a software element executed by a processor, or any combination thereof. The embodiments are not limited in this context.

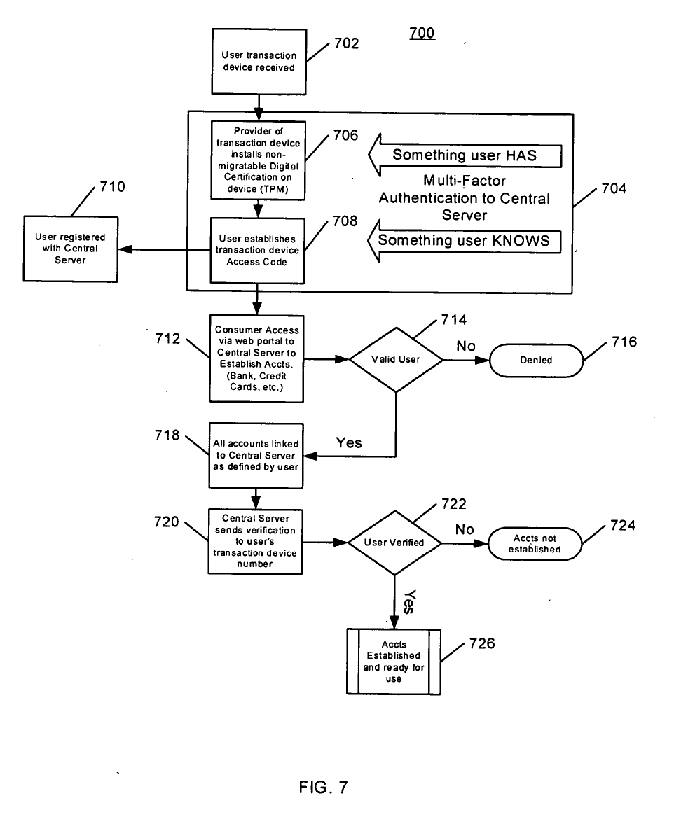

FIG. 7 illustrates a programming logic 700. Programming logic 700 may be representative of the operations executed within the environment of or by one or more systems described herein, such as systems 100, 600. Programming logic 700 will be described with reference to elements associated with FIG. 6, for example, although the same principles apply to system 100 shown in FIG. 1, and specific examples of these elements shown in FIGS. 2-5, for example. Accordingly, as shown in programming logic 700 a user may establish an account in central infrastructure 608 at central server 610, for example, according to the following logic. Also, although reference is made to central server 610, the information may be exchanged with any one of servers 610, 612, 614, and 618 comprising central infrastructure 608. At block 702 the user receives transaction device 602. At block 704 the user performs a multi-factor authentication with central server 610. For example, at block 706, the provider of transaction device 602 installs a non-migratable digital certification on transaction device 602 (TPM). This may be referred to as a first factor authentication to central server 610 related to something the user physically must have, such as transaction device 602. At block 708 the user establishes a transaction device 602 access code with central server 610. This may be referred to as a second factor authentication to central server 610 related to something the user knows, such as, for example, an automated teller machine (ATM) like personal identification number (PIN) number. In one embodiment, the user may establish a third authentication factor to central server 610 using some form of biometrics such as, for example, finger print, retinal scan, and so forth. Once the user has completed actions associated with blocks 702-708, at block 710 the user is registered with central server 610.

Once properly registered with central server 610, at block 712, the user may access central server 610 via a web portal to central server 610 to establish accounts therein, such as, for example, bank and credit card accounts. Decision block 714 determines if the user is a valid user. If the user in not a valid user, the system proceeds to the “no” branch and at block 716 access to central server 610 is denied. If the user is a valid user, the system proceeds to the “yes” branch to block 718, where all user accounts are linked to central server 610 as defined by the user. At block 720, central server 610 sends a verification to the user's transaction device number. Decision block 722 determines if the user is verified. If the user is not verified, the system proceeds to the “no” branch and to block 724, thus the accounts are not established. If the user is verified, the system proceeds to the “yes” branch and at block 726 the user's accounts are established and ready for use.

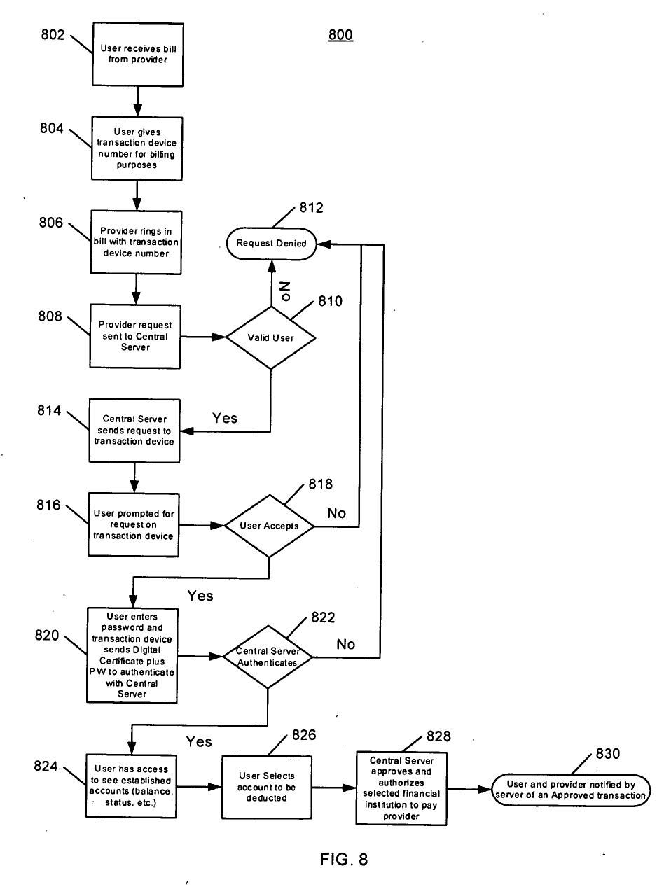

FIG. 8 illustrates a programming logic 800. Programming logic 800 may be representative of the operations executed within the environment of or by one or more systems described herein, such as systems 100, 600. Programming logic 800 will be described with reference to elements associated with FIG. 6, for example, although the same principles apply to system 100 shown in FIG. 1, and specific examples of these elements shown in FIGS. 2-5, for example.

Accordingly, a payment process in accordance with various embodiments is shown in programming logic 800. At block 802, a user receives a bill from a provider in the process of a purchase transaction, for example. At block 804, the user gives the provider the call number of transaction device 602 for billing purposes. In one embodiment, for example, the user may give to the provider the user's cell phone number. At block 806, the provider rings in the bill along with the transaction device number. Accordingly, the provider's request is transmitted to central server 610. As previously described, although reference is made to central server 610, the information may be exchanged with any one of servers 610, 612, 614, and 618 comprising central infrastructure 608. At decision block 810, central server 610 determines whether the user is a valid user, and if not, the process continues along the “no” branch at block 812 the provider's request is denied. If central server 610 determines that the user is a valid user, at decision block 810, the process continues along the “yes” branch to block 814 and the user is prompted for a request on transaction device 602. Decision block 818 determines if the user has accepted the request. If the user has not accepted, the process continues along “no” branch to block 812 and the request is denied. If the user has accepted the request, the process continues along the “yes” branch to block 820. At block 820 the user enters the user's password and transaction device 602 sends the digital certificate plus the user's password to authenticate with central server 610. At decision block 822, if central server 610 does not authenticate, the process continues along “no” branch and at block 812 the request is denied. If central server 610 does authenticate, the process continues along “yes” branch to block 824 and the user now has access to view information associated with established accounts (e.g., balance, status, and so forth). At block 826, the user selects the account to be deducted for the purchase transaction. At block 828, central server 610 approves and authorizes the selected financial institution to pay the provider. At block 830, the user and provider are notified by central server 610 of an approved transaction.

Numerous specific details have been set forth herein to provide a thorough understanding of the embodiments. It will be understood by those skilled in the art, however, that the embodiments may be practiced without these specific details. In other instances, well-known operations, components and circuits have not been described in detail so as not to obscure the embodiments. It can be appreciated that the specific structural and functional details disclosed herein may be representative and do not necessarily limit the scope of the embodiments.

It is also worthy to note that any reference to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

Some embodiments may be implemented using an architecture that may vary in accordance with any number of factors, such as desired computational rate, power levels, heat tolerances, processing cycle budget, input data rates, output data rates, memory resources, data bus speeds and other performance constraints. For example, an embodiment may be implemented using software executed by a general-purpose or special-purpose processor. In another example, an embodiment may be implemented as dedicated hardware, such as a circuit, an application specific integrated circuit (ASIC), Programmable Logic Device (PLD) or digital signal processor (DSP), Trusted Platform Module (TPM), and so forth. In yet another example, an embodiment may be implemented by any combination of programmed general-purpose computer components and custom hardware components. The embodiments are not limited in this context.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, various types of Digital Versatile Disk (DVD), a tape, a cassette, or the like. The instructions may include any suitable type of code, such as source code, compiled code, interpreted code, executable code, static code, dynamic code, and the like. The instructions may be implemented using any suitable high-level, low-level, object-oriented, visual, compiled and/or interpreted programming language, such as C, C++, Java, BASIC, Perl, Matlab, Pascal, Visual BASIC, XML (Extensible Markup Language), TPM, SOAP, Electronic Commerce Modeling Language (ECML), Security Assertion Markup Language (SAML), Federated Identity Management Model (FIM), Single Sign On (SSO), Cross Domain Single Sign On (CDSSO), (ebXML), Financial Products Markup Language (FpML), (FIXML), Interactive Financial eXchange (IFX), ISO 15022, Market Data Definition Language (MDDL), (NewsML), News Industry Text Format (NITF), Open Financial Exchange (OFX), (RELAX NG), Research Information eXchange Markup Language (RIXML), Schematron, (swiftML), eXtensible Business Reporting Language (XBRL), eXtensible HyperText Markup Language (XHTML). Additional programming languages may include, for example, assembly language, machine code, and so forth. The embodiments are not limited in this context.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within the computing system's registers and/or memories into other data similarly represented as physical quantities within the computing system's memories, registers or other such information storage, transmission or display devices. The embodiments are not limited in this context.

While certain features of the embodiments have been illustrated as described herein, many modifications, substitutions, changes and equivalents will now occur to those skilled in the art. It is therefore to be understood that the appended claims are intended to cover all such modifications and changes as fall within the true spirit of the embodiments.

1. A method, comprising:
registering with a server with a transaction device comprising a digital certification;
accessing a portal to establish at least one account at said server; and
linking all accounts at said server to said transaction device.

2. The method of claim 1, wherein registering further comprises:
establishing a call with said transaction device comprising said digital certification to a server; and
establishing a first access code on said server.

3. The method of claim 1, further comprising said server transmitting a verification message to said transaction device.

4. The method of claim 3, further comprising:
verifying said transaction device based on said digital certificate and said access code; and
establishing said account based on a response from said verification message.

5. The method of claim 2, further comprising establishing a second access code on said server.

6. A method, comprising:
providing a number associated with a transaction device for payment to a provider by a user, said transaction device comprising a digital certificate;
transmitting a payment request to a server based on said number; and
enabling payment from a predetermined account associated with said number based on said digital certificate.

7. The method of claim 6, further comprising determining if said number is valid prior to enabling payment.

8. The method of claim 7, further comprising said server prompting said transaction device for said user request to authorize payment.

9. The method of claim 6, further comprising:
authenticating said transaction device with said server based on a password and said digital certificate; and
when authenticated, enabling access to a financial account through said server.

10. The method of claim 9, further comprising:
selecting said financial account to be deducted for payment;
said server, approving and authorizing payment from said selected financial account; and
notifying said provider and said user of an approved payment transaction.

11. An apparatus, comprising:
a server in communication with a communication network, wherein said server is to register a transaction device comprising a digital certification and to provide access to said transaction device to establish at least one account at said server and to link all accounts at said server to said transaction device.

12. The apparatus of claim 11, wherein said server is to receive a call from said transaction device comprising said digital certification and to establish a first access code.

13. The apparatus of claim 11, wherein said server is to transmit a verification message to said transaction device.

14. The apparatus of claim 13, wherein said server is to verify said transaction device based on said digital certificate and said access code and to establish said account based on a response from said verification message.

15. The apparatus of claim 12, wherein said server is to establish a second access code.

16. An apparatus, comprising:
a server in communication with a communication network, wherein said server is to receive a payment request based on a number associated with a transaction device for payment to a provider by a user, said transaction device comprising a digital certificate and wherein said server is to enable payment from a predetermined account associated with said number based on said digital certificate.

17. The apparatus of claim 16, wherein said server is to determine if said number is valid prior to enabling payment.

18. The apparatus of claim 17, wherein said server is to prompt said transaction device for a user request to authorize payment.

19. The apparatus of claim 16, wherein said server is to authenticate said transaction device with said server based on a password and said digital certificate and when authenticated, said server is to enable access to a financial account through said server.

20. The apparatus of claim 19, wherein said server is to select said financial account to be deducted for payment based on a user selection; to approve and authorize payment from said selected financial account; and to notify said provider and said user of an approved payment transaction.

21. The apparatus of claim 16, further comprising:
a transceiver to connect to said server;
an antenna to connect to said transceiver; and
wherein said antenna and transceiver are to receive said payment request.
